(19) United States
(12) Patent Application Publication
(10) Pub. No.: US 2014/0344568 A1
(43) Pub. Date: Nov. 20, 2014

(54) SERVER NODE DISCOVERY MECHANISM APPLIED IN CLOUD ENVIONMENT CAPABLE OF SEARCHING SERVER NODE WITHIN CLOUD SERVICE CLUSTER

(71) Applicant: HON HAI PRECISION INDUSTRY CO., LTD., New Taipei (TW)

(72) Inventor: JIA-RU YANG, New Taipei (TW)

(73) Assignee: HON HAI PRECISION INDUSTRY CO., LTD., New Taipei (TW)

(21) Appl. No.: 14/279,461

(22) Filed: May 16, 2014

(30) Foreign Application Priority Data
May 17, 2013 (TW) 102117511

(51) Int. Cl. H04L 29/06

(52) U.S. Cl. CPC H04L 63/0428
USPC 713/162

(57) ABSTRACT

A packet sending node is employed in a network segment. The packet sending node includes a packet storage module, a packet sending module and a packet accepting module. The packet storage module is configured to store an encryption packet including a network address of the packet sending node. The packet sending module is configured to send the encryption packet to a packet receiving node in the network segment based on the user datagram protocol. The packet accepting module is configured to receive a response packet sent by the packet receiving node according to the network address of the packet sending node in the encryption packet. A server node discovery mechanism and a packet receiving module are also provided.

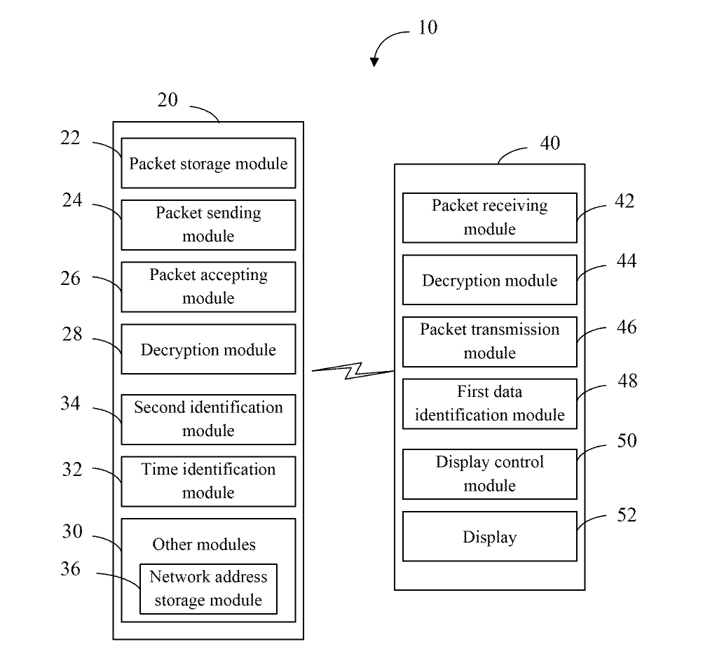

### FIELD

The present disclosure relates to a discovery mechanism, especially relates to a server node discovery mechanism, a discovery packet sending node and a discovery packet receiving node applied in a cloud service cluster capable of searching server nodes within the cloud service cluster.

### BACKGROUND

Server nodes are base components for building cloud services in a cloud service cluster. In order to search server nodes within the packet center, a manager node of the cloud service cluster broadcasts discovery packet to other server nodes of the cloud service cluster based on a user datagram protocol. When the other server nodes of the cloud service cluster receives the discovery packet and responds, the manager node which broadcasts the discovery packet can obtain network addresses of the responding server nodes. Because any one of the server node in the network segment can receive the discovery packet, if a malicious hacker receives the discovery packet via one server node of the cloud service cluster, the malicious hacker may retransmit the discovery packet in the network segment, when the other server nodes respond, the malicious hacker also can obtain the network addresses of the responding server nodes, than the malicious hacker can attack the other server nodes according to the obtained network addresses.

### BRIEF DESCRIPTION OF THE DRAWING

The components in the drawing are not necessarily drawn to scale, the emphasis instead being placed upon clearly illustrating the principles of the disclosure.

The FIGURE is a block diagram of a packet transmission system.

### DETAILED DESCRIPTION

The FIGURE shows a server node discovery mechanism 10. The server node discovery mechanism 10 is employed in a network segment. The server node discovery mechanism 10 includes a packet sending node 20 and at least one packet receiving node 40. The packet sending node 20 and the at least one packet receiving node 40 transmit packet in the network segment based on a user datagram protocol.

The packet sending node 20 includes a packet storage module 22, a packet sending module 24, and a packet accepting module 26. The packet storage module 22 is configured to store encryption packet. The encryption packet includes a network address of the packet sending node 20. The packet sending module 24 is configured to send the encryption packet to the at least one packet receiving node 40 in the network segment based on the user datagram protocol.

Each packet receiving node 40 includes a packet receiving module 42, an decryption module 44 and a packet transmission module 46. The packet receiving module 42 is configured to receive the encryption packet transmitted from the packet sending node 20. The decryption module 44 is configured to decrypt the encryption packet via a first preset key by the user of the said packet receiving node 40. The decrypted packet includes the network address of the packet sending node 20. Because the packet sending node 20 sends the encryption packet, even if a malicious hacker obtains the encryption packet by the packet receiving node 40, the malicious hacker does not know the first preset key, therefore the malicious hacker cannot decrypt the encryption packet. Thus, the malicious hacker can not obtain or tamper the network address of the packet sending node 20. If the system of the packet receiving node 40 successfully decrypts the encryption packet applying the first preset key via the decryption module 44, the system of the packet receiving node 40 sends a response packet to the packet sending node 20 corresponding to the network address in the decrypted packet via the packet transmission module 46. The packet accepting module 26 is configured to receive the response packet transmitted from the packet receiving node 40.

In at least one embodiment, the packet receiving node 40 further includes a first packet identification module 48, a display control module 50 and a display 52. The encryption packet transmitted by the packet sending node 20 further includes a first packet identification information. Correspondingly, the decrypted packet also includes the first packet identification information. The decryption module 44 is further configured to send a successful decryption signal to the first packet identification module 48 if the encryption packet is successfully decrypted. The first packet identification module 48 is configured to determine whether the first packet identification information in the decrypted packet conforms with a first preset identification information in response to the successful decryption signal, and sends a legal packet signal to the display control module 50 if the first packet identification information in the decrypted packet conforms with the first preset identification information, and sends a illegal packet signal to the display control module 50 when the first packet identification information in the decrypted packet does not conform with the first preset identification information. The display control module 50 is configured to display packet successful identification information on the display 52 in response to the legal packet signal and display packet unsuccessful identification information on the display 52 in response to the illegal packet signal. The system of the packet receiving node 40 sends the response packet to the packet sending node 20 corresponding to the network address in the decrypted packet based on the packet successful identification information displayed on the display 52 via the packet transmission module 46. In at least one embodiment, the first packet identification information is a version number.

In another alternative embodiment, the system of the packet receiving node 40 determines whether the decrypted packet is an authentic packet based on the first packet identification information in the decrypted packet. If the system of the packet receiving node 40 determines the first packet identification information has been successfully identified, the system of the packet receiving node 40 sends the response packet to the packet sending node 20 corresponding to the network address in the decrypted packet via the packet transmission module 46.

Because the packet receiving node 40 sends the response packet to packet sending node 20 corresponding to the network address in the decrypted packet, even if the malicious hacker obtains the encryption packet by another packet receiving node 40 in the network segment and sends the encryption packet to the other nodes in the network segment based on the user datagram protocol, the other nodes send the response packet to the packet sending node 20 corresponding to the network address in the decrypted packet after the other nodes obtain the encryption packet, but not to the packet receiving node 40 which the malicious hacker uses, thus the malicious hacker cannot obtain the system information of the other node in the network segment.

In at least one embodiment, the response packet transmitted from the packet receiving module 40 is encrypted. The packet sending node 20 further includes a decryption module 28. The decryption module 28 is configured to decrypt the encrypted response packet via a second preset key for the user. The system of the packet sending node 20 determines whether the packet receiving module 40 sending the encrypted response packet is legal based on whether the encrypted response packet is successfully decrypted via the second preset key and do an operation based on the determination. If the encrypted response packet is successfully decrypted via the second preset key, the system of the packet sending node 20 will certify the system of packet receiving node 40 as a valid member node of the cluster service. If the encrypted response packet is unsuccessfully decrypted via the second preset key, the system of the packet sending node 20 will disqualify the system of packet receiving node 40. In at least one embodiment, the second preset key is same as the first preset key.

In at least one embodiment, the decryption module 28 of the packet sending node 20 is further configured to send a legal signal to other modules 30 of the packet sending node 20 to actuate programs corresponding to the other modules 30.

At the least one embodiment, the encrypted response packet transmitted from the packet receiving node 40 includes second packet identification information. Correspondingly, the decrypted response packet also includes the second packet identification information. In an exemplary embodiment, the second packet identification information is a version number. The packet sending node 20 further includes a second identification module 34. The second packet identification module 34 is configured to determine whether the second packet identification information in the decrypted response packet conforms with second preset identification information when the encrypted response packet is successfully decrypted, and sends a legal signal to other modules 30 of the packet sending node 20 to actuate programs corresponding to the other modules 30.

At the least one embodiment, the packet sending node 20 further includes a time identification module 32. The time identification module 32 is configured to calculate a time period from sending the encryption packet by the packet sending node 20 to receive the encrypted response packet by the packet sending node 20 and determine whether the time period is less than a preset period if the encrypted response packet has been successfully decrypted. If the time period is less than the preset period, the time identification module 48 sends a legal signal to other modules 30 of the packet sending node 20 to actuate programs corresponding to the other modules 30.

At the least one embodiment, the other modules 30 includes a network address storage module 36. The network address storage module 36 is configured to store the network address of the packet receiving node 40 transmitting the response packet based on the legal signal.

While numerous characteristics and advantages of the present disclosure have been set forth in the foregoing description, together with details of the structure and function of the present disclosure, the present disclosure is illustrative only, and changes may be made in detail, including in matters of shape, size, and arrangement of parts within the principles of the present disclosure to the full extent indicated by the broad general meaning of the terms in which the appended claims are expressed.

What is claimed is:

1. A server node discovery mechanism employed in a network segment and transmitting packet based on a user datagram protocol, the server node discovery mechanism comprising:
a packet sending node comprising:
a packet storage module configured to store encryption packet, the encryption packet comprising a network address of the packet sending node; and
a packet sending module configured to send the encryption packet;
at least one packet receiving node, each packet receiving node comprising:
a packet receiving module configured to receive the encryption packet;
an decryption module configured to decrypt the encryption packet via a first preset key; and
a packet transmission module configured to transmit response packet to the packet sending node corresponding to the network address in the decrypted packet when the encryption packet is successfully decrypted via the first preset key.

2. The server node discovery mechanism as claimed in claim 1, wherein the packet sending node further comprising a packet accepting module, the packet accepting module configured to receive the response packet transmitted from the packet receiving node.

3. The server node discovery mechanism as claimed in claim 1, wherein the response packet is encrypted, the packet sending node further comprises a decryption module, the decryption module is configured to decrypt the encrypted response packet via a second preset key.

4. The server node discovery mechanism as claimed in claim 3, wherein the second preset key is same as the first preset key.

5. The server node discovery mechanism as claimed in claim 3, wherein the decryption module is further configured to send a legal signal to other modules of the packet sending node to actuate programs corresponding to the other modules when the encrypted response packet is successfully decrypted.

6. The server node discovery mechanism as claimed in claim 3, wherein the encrypted response packet comprises a packet identification information, the packet sending node further comprises a identification module, the packet identification module is configured to determine whether the packet identification information in the decrypted response packet conforms with a preset identification information if the encrypted response packet is successfully decrypted, and send a legal signal to other modules of the packet sending node to actuate programs corresponding to the other modules when the packet identification information in the decrypted response packet conforms with the preset identification information.

7. The server node discovery mechanism as claimed in claim 1, wherein the packet sending node further comprises a time identification module, the time identification module is configured to calculate a time period from sending the encryption packet by the packet sending node to receive the response packet by the packet sending node and determine whether the time period is less than a preset period, if the time period is less than the preset period, the time identification module sends a legal signal to other modules of the packet sending node to actuate programs corresponding to the other modules.

8. A packet sending node employed in a network segment, the packet sending node comprising:
a packet storage module configured to store an encryption packet, the encryption packet comprising a network address of the packet sending node;
a packet sending module configured to send the encryption packet to at least one packet receiving node in the network segment based on a user datagram protocol; and
a packet accepting module configured to receive a response packet, the response packet transmitted from the at least one packet receiving node according to the network address of the packet sending node in the encryption packet.

9. The packet sending node as claimed in claim 8, wherein the response packet is encrypted, the packet sending node further comprises a decryption module, the decryption module is configured to decrypt the encrypted response packet via a preset key.

10. The packet sending node as claimed in claim 9, wherein the decryption module is further configured to send a legal signal to other modules of the packet sending node to actuate programs corresponding to the other modules when the encrypted response packet is successfully decrypted via the preset key.

11. The packet sending node as claimed in claim 9, wherein the encrypted response packet comprises a packet identification information, the packet sending node further comprises a identification module, the packet identification module is configured to determine whether the packet identification information in the decrypted response packet conforms with a preset identification information if the encrypted response packet is successfully decrypted, and send a legal signal to other modules of the packet sending node to actuate programs corresponding to the other modules when the packet identification information in the decrypted response packet conforms with the preset identification information.

12. The packet sending node as claimed in claim 8, wherein the packet sending node further comprises a time identification module, the time identification module is configured to calculate a time period from sending the encryption packet by the packet sending node to receive the e response packet by the packet sending node and determine whether the time period is less than a preset period if the encrypted response packet is successfully decrypted, if the time period is less than the preset period, the time identification module sends a legal signal to other modules of the packet sending node to actuate programs corresponding to the other modules.

13. A packet receiving node employed in a network segment, the packet receiving node comprising:
a packet receiving module configured to receive an encryption packet transmitted from a packet sending node based on a user datagram protocol, the encryption packet comprising a network address of the packet sending node;
a decryption module configured to decrypt the encryption packet via a preset key; and
a packet transmission module configured to transmit a response packet to the packet sending node corresponding to the network address in the decrypted packet when the encryption packet is successfully decrypted via the preset key.

14. The packet receiving node as claimed in claim 13, wherein the encryption packet further comprising a packet identification information, the packet receiving node further comprises a packet identification module, the packet identification module is configured to determine whether the packet identification information in the decrypted packet conforms with a preset identification information when the encryption packet is successfully decrypted via the preset key, and send a packet legal signal if the packet identification information in the decrypted packet conforms with the preset identification information, the packet transmission module transmits the response packet to the packet sending node corresponding to the network address in the decrypted packet according to the packet legal signal.
